(19) United States
(12) Patent Application Publication
(10) Pub. No.: US 2017/0299151 A1
(43) Pub. Date: Oct. 19, 2017

(54) BULB STRUCTURE

(71) Applicant: YU LUO, SHENZHEN (CN)

(72) Inventor: YU LUO, SHENZHEN (CN)

(21) Appl. No.: 15/132,442

(22) Filed: Apr. 19, 2016

(51) Int. Cl. F21V 14/02; F21V 29/76; F21K 9/237; F21V 19/00; F21V 1/00; F21Y 2115/10

(52) U.S. Cl. CPC F21V 14/02; F21V 19/003; F21V 1/00; F21V 29/763; F21K 9/237; F21Y 2115/10

(57) ABSTRACT

The present invention relates to a bulb structure, which comprises a bulb base, a pole member, a transmission base, and a plurality of lamp leaves. One end of the pole member is disposed at the bulb base. The transmission base is disposed at the other end of the pole member. The plurality of lamp leaves are disposed pivotally surrounding the transmission base and located surrounding the pole member. The plurality of lamp leaves pivot on the transmission base and move away from the pole member. The bulb structure according to the present invention includes two lighting patterns. The lamp leaves may spread or close. Thereby, different lighting ranges may be provided.

### FIELD OF THE INVENTION

The present invention relates generally to a bulb, and particularly to a bulb structure having spreadable and retractable lamp leaves.

### BACKGROUND OF THE INVENTION

A lamp is an important invention of humans. It brings significant convenience to people's lives. As technologies advance day by day, various types of lamps with respective advantages are provided in the market. Lamps including incandescent lamps, fluorescent lamps, halogen lamps, electrodeless lamps, mercury-free lamps, and lighting LEDs, own their optoelectric characteristics, safety properties, environmental protection properties, and price-performance ratios. LEDs have strong potential in lighting applications. Their applications and market share will expand rapidly.

As lighting technologies develop, the figure of merit for future lighting is not limited to the lighting range only. The lighting effects, comfort, biological effects, safety, environmental protection, and resource consumption are evaluated as well. LEDs own the advantages of low power consumption and long lifetime. Thereby, no matter in public or domestic lighting, they have started to replace current incandescent lamps and power-saving lamps gradually; the related products of LEDs are also developing prosperously and increasingly.

The light emitted by the LED chips in the LED bulb structure according to the prior art is directional. Thereby, other structures or devices are required to scatter the light, so that the LED bulb structure can emit uniform light instead of directional light. Alternatively, a plurality of LED chips can be disposed in a bulb structure at various directions. Consequently, the light paths of the light emitted by the LED chips can encompass the environment uniformly. Nonetheless, the method of changing the light of the LED bulb structure is still limited. In addition, the LED bulb structures according to the prior art are mostly fixed. There are few ways to change the lighting method.

The drawback of the light-emitting methods of the LED bulb structure according to the prior art is their fixed configuration, which makes their usage in lighting inflexible. Accordingly, the present invention provides a bulb structure to solve the above drawback according to the prior.

### SUMMARY

An objective of the present invention is to provide a bulb structure, which may change the structure of a lamp for satisfying various lighting ranges.

Another objective of the present invention is to provide a bulb structure, which may change the structure of a lamp for improving heat dissipation.

The present invention provides a bulb structure, which comprises a bulb base, a pole member, a transmission base, and a plurality of lamp leaves. One end of the pole member is disposed at the bulb base. The transmission base is disposed at the other end of the pole member. The plurality of lamp leaves are disposed pivotally surrounding the transmission base and located surrounding the pole member. The plurality of lamp leaves pivot on the transmission base and move away from the pole member.

According to an embodiment, the transmission base further comprises a base, which includes a plurality of first pivot structures. Each first pivot structure includes a pivot groove and two pivot holes. The two pivot holes are located on the two sidewalls of the pivot groove and opposing to each other. Each lamp leaf is disposed pivotally at the transmission base and includes a housing. The housing includes a second pivot structure, which includes a pivot member and two pivot bumps. The two pivot bumps are disposed on both sides of the pivot member and opposing to each other. The pivot member is wedged into the pivot groove. The two pivot bumps are wedged into the two pivot holes, respectively.

According to an embodiment of the present invention, each first pivot structure further includes two fixing bumps disposed on the two sidewalls of the pivot groove. Each second pivot structure is disposed pivotally at each first pivot structure and includes a plurality of penetrating holes at the pivot member. The two fixing bumps are wedged into the two openings of one of the plurality penetrating holes, respectively, such that each lamp leaf forms an angle with respect to the base. Each lamp leaf pivots on the base and includes a plurality of angles. The plurality of angles correspond to the locations of the plurality of penetrating holes.

According to an embodiment of the present invention, each first pivot structure further includes two fixing bumps disposed on the two sidewalls of the pivot groove. Each second pivot structure is disposed pivotally at each first pivot structure and includes one or more penetrating hole at the pivot member. The two fixing bumps are wedged into the two openings of the one or more penetrating hole, respectively.

According to an embodiment of the present invention, each fixing bump further includes a pillar body disposed on the sidewall of the pivot groove and a round head disposed at the pillar body.

According to an embodiment of the present invention, the two openings of each penetrating hole include a guiding opening, respectively.

According to an embodiment of the present invention, each lamp leaf includes a housing, a base board, and a plurality of LED chips. The housing includes a lamp-leaf accommodating cavity. The base board is disposed in the lamp-leaf accommodating cavity. The plurality of LED chips are disposed on the base board.

According to an embodiment of the present invention, each lamp leaf includes a lampshade and a heat sink. The lampshade is disposed over the lamp-leaf accommodating cavity. The heat sink surrounds the periphery of the housing and is located outside the lampshade.

According to an embodiment of the present invention, each lamp leaf further includes a housing and a plurality of heat dissipating fins disposed on one side of the housing.

According to an embodiment of the present invention, the transmission base further includes a base, a base board, a plurality of LED chips, and a lampshade. The base includes a base accommodating cavity. The base board is disposed in the base accommodating cavity. The plurality of LED chips are disposed on the base board. The lampshade is disposed over the base accommodating cavity and covers the plurality of LED chips.

### BRIEF DESCRIPTION OF THE DRAWINGS

FIG. 1 shows a stereoscopic view of the bulb structure according to an embodiment of the present invention;

FIG. 2 shows another stereoscopic view of the bulb structure according to an embodiment of the present invention;

FIG. 3A shows an exploded view of the bulb structure according to an embodiment of the present invention;

FIG. 3B shows an enlarged view of the region A in FIG. 3A;

FIG. 3C shows an enlarged view of the region B in FIG. 3A;

FIG. 4A shows a schematic diagram of using the bulb structure according to an embodiment of the present invention;

FIG. 4B shows another schematic diagram of using the bulb structure according to an embodiment of the present invention;

FIG. 4C shows a further schematic diagram of using the bulb structure according to an embodiment of the present invention;

FIG. 5 shows a stereoscopic view of the lamp leaf of the bulb structure according to an embodiment of the present invention;

FIG. 6 shows a stereoscopic view of the transmission base of the bulb structure according to an embodiment of the present invention; and

FIG. 7 shows a stereoscopic view of the heat dissipating fins of the bulb structure according to an embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

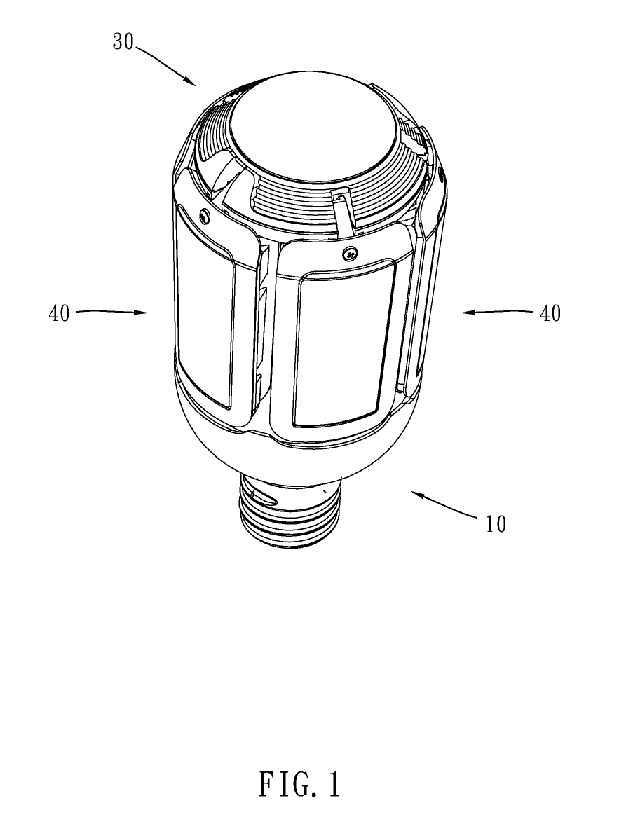

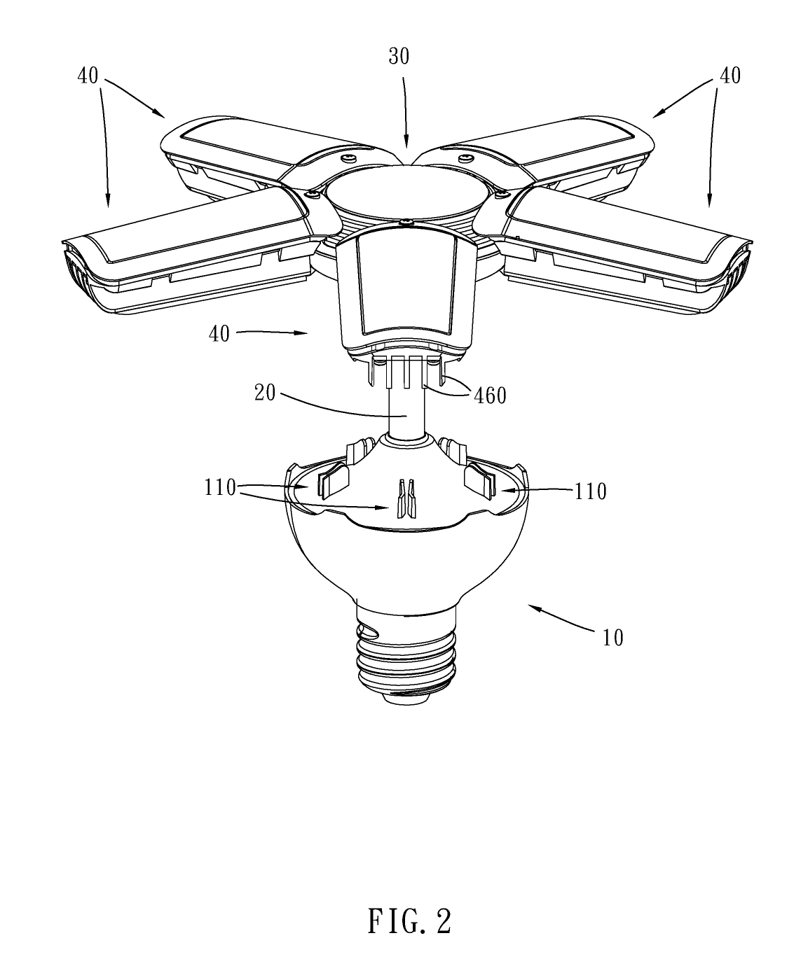

Please refer to FIG. 1 and FIG. 2, which show a stereoscopic view and another stereoscopic view of the bulb structure according to an embodiment of the present invention. As shown in the figures, the present embodiment provides a bulb structure 1, which may change a portion of the structure of a lamp and thus changing the illuminating angles of the lamp and further controlling the lighting ranging. The bulb structure 1 comprises a bulb base 10, a pole member 20, a transmission base 30, and a plurality of lamp leaves 40.

One end of the pole member 20 is disposed at the bulb base 10. The transmission base 30 is disposed at the other end of the pole member 20. The plurality of lamp leaves 40 are disposed pivotally surrounding the transmission base 30 and located surrounding the pole member 20. The plurality of lamp leaves 40 pivot on the transmission base 30 and move away from the pole member. Thereby, the bulb structure 1 may change the angle of each lamp leaf 40 freely via the transmission base 30 and thus changing the lighting range of the plurality of lamp leaves 40.

According to the present embodiment, the number of the plurality of lamp leaves 40 is five. Nonetheless, the present embodiment does not limit the number of the lamp leaves 40; it may be adjusted according users' requirements. The present embodiment includes one or more structure states (namely, the lighting patterns). As shown in FIG. 1, the first structure state is depicted. One end of the plurality of lamp leaves 40 is disposed pivotally at the transmission base 30. The other end hangs opposing to the bulb base 10. Thereby, the plurality of lamp leaves 40 and the pole member 20 are parallel and the former cover the periphery of the latter. The bulb structure 1 is in the closed state. When the bulb structure 1 is in the usage state, the light emitted from the plurality of lamp leaves 40 illuminates towards the surroundings.

In addition, as shown in FIG. 2, the second structure state is depicted. One end of the plurality of lamp leaves 40 pivots on the transmission base 30 such that the other end of the plurality of lamp leaves 40 moves away from the bulb base 10 and the pole member 20. The plurality of lamp leaves 40 no longer cover the pole member 20. Instead, the pole member 20 is exposed. The plurality of lamp leaves 40 spread to the same plane. Then the bulb structure 1 becomes completely spread. When the bulb structure 1 is in the usage state, the light emitted from the plurality of lamp leaves 40 illuminates towards the same direction and hence the light is more concentrated. Besides, the transmission base 30 according to the present embodiment may control the pivoting of a single lamp leaf 40 or all of the plurality of lamp leaves 40. In other words, some lamp leaves 40 are spread while some are closed. In addition, the pivoting angles of the plurality of lamp leaves 40 on the transmission base 30 are not limited. Users may adjust the pivoting angles according to their requirements.

The present invention is provided to improve the drawbacks in the prior art. The LED bulb structure according to the prior art is a fixed lighting pattern; its structure is unchangeable. The lighting range of the light emitted by the LED structure is fixed according to the structure design. The lighting range cannot be changed, making applications inflexible. Accordingly, the present invention provides a bulb structure. The advantage of the present invention is that the plurality of lamp leaves 40 may pivot on the transmission base 30. According to user's requirements, the plurality of lamp leaves 40 may spread or close and thus changing the lighting range of the plurality of lamp leaves 40. In addition, according to the design of the bulb structure 1, there is a gap between the plurality of lamp leaves 40 and the bulb base 10. The air in this gap may block heat conduction between the plurality of lamp leaves 40 and the bulb base 10. Hence, the high temperature generated by the LED chips in the plurality of lamp leaves 40 is difficult to influence the temperature of the driving module (not shown in the figure) in the bulb base 10, maintaining normal operations of the driving module as well as extending the lifetime of the bulb structure 1. In addition, when the bulb structure 1 is in the second structure state (spread), it is favorable for the heat dissipation of the plurality of lamp leaves 40 using air convection. Furthermore, the plurality of lamp leaves 40 include two or more structure states, such as the closed state of the first one and the spread state of the second. They may be used for decorating lamps.

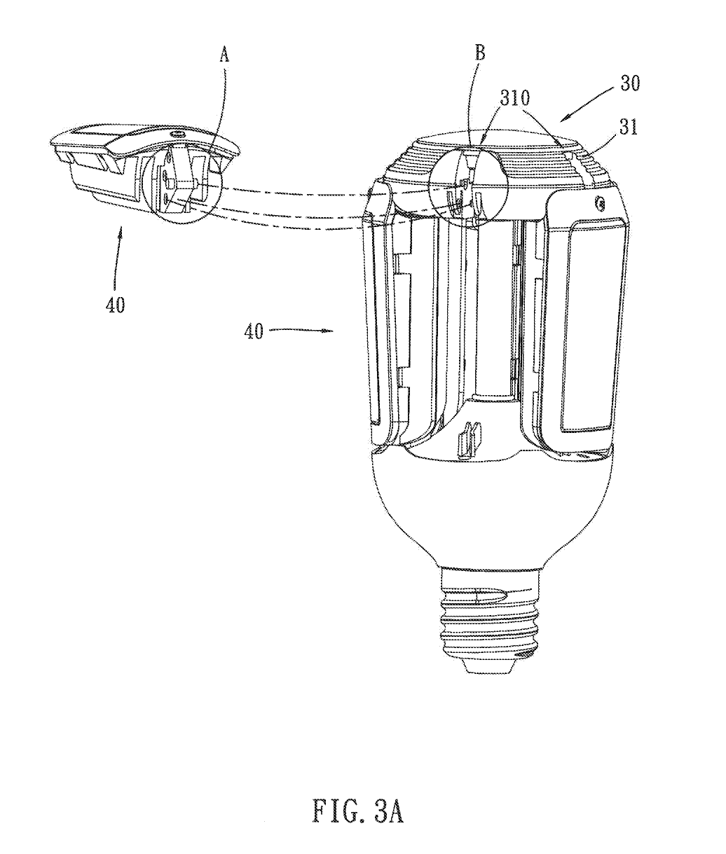

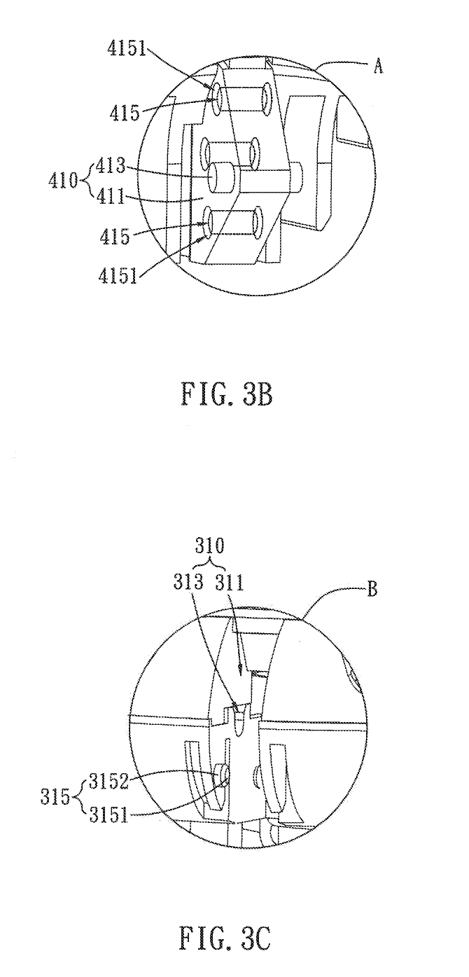

Please further refer to FIGS. 3A to 3C, which show an exploded view of the bulb structure according to an embodiment of the present invention and enlarged views of the regions A, B in FIG. 3A. As shown in the figures, the present embodiment describes the pivot structure of each lamp leaf 40 on the transmission base 30. The transmission base further includes a base 31. The base 31 includes a plurality of first pivot structures 310. Each first pivot structure 310 includes a pivot groove 311 and two pivot holes 313. The two pivot holes 313 are located on the two sidewalls of the pivot groove 311 and opposing to each other. Each lamp leaf 40 further includes a housing 41. The housing 41 includes a second pivot structure 410, which includes a pivot member 411 and two pivot bumps 413. The two pivot bumps 413 are disposed on both sides of the pivot member 411 and opposing to each other. The second pivot structure 410 is disposed pivotally at the first pivot structure 310. Namely, the pivot member 411 is wedged into the pivot groove 311. The two pivot bumps 413 are wedged into the two pivot holes 313, respectively. Thereby, the two pivot bumps 413 and the two pivot holes 313 are pivot axes so that each lamp leaf 40 may pivot on the transmission base 30.

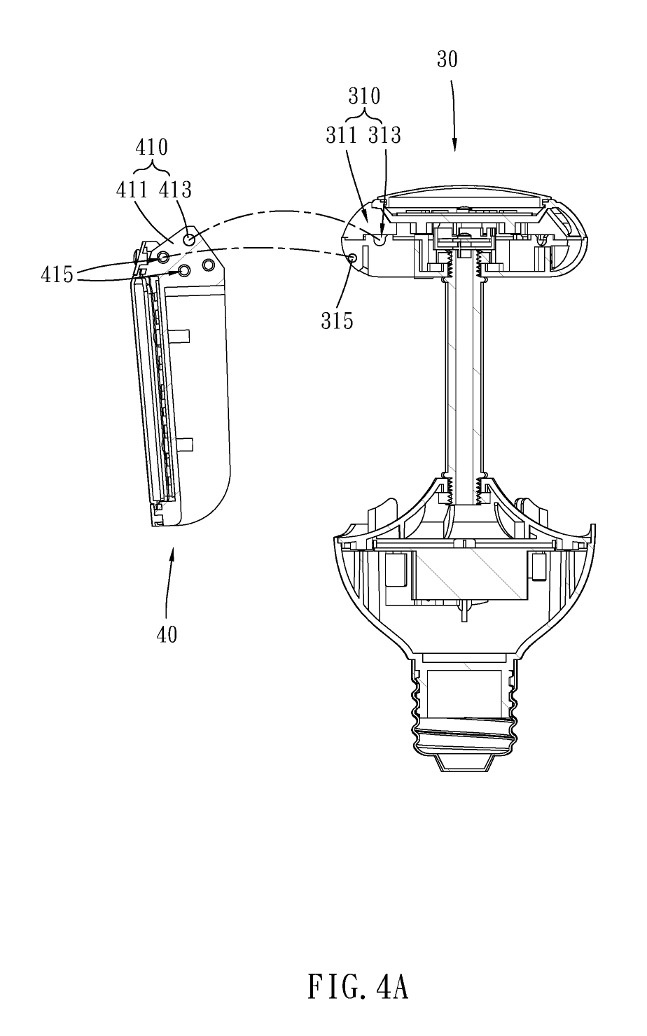

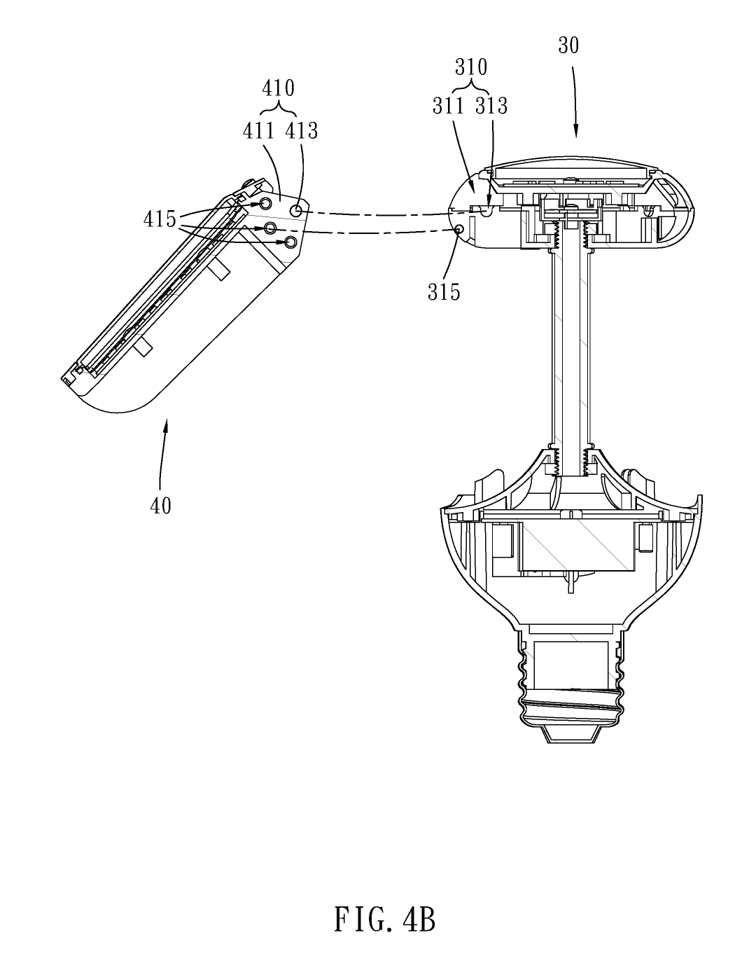

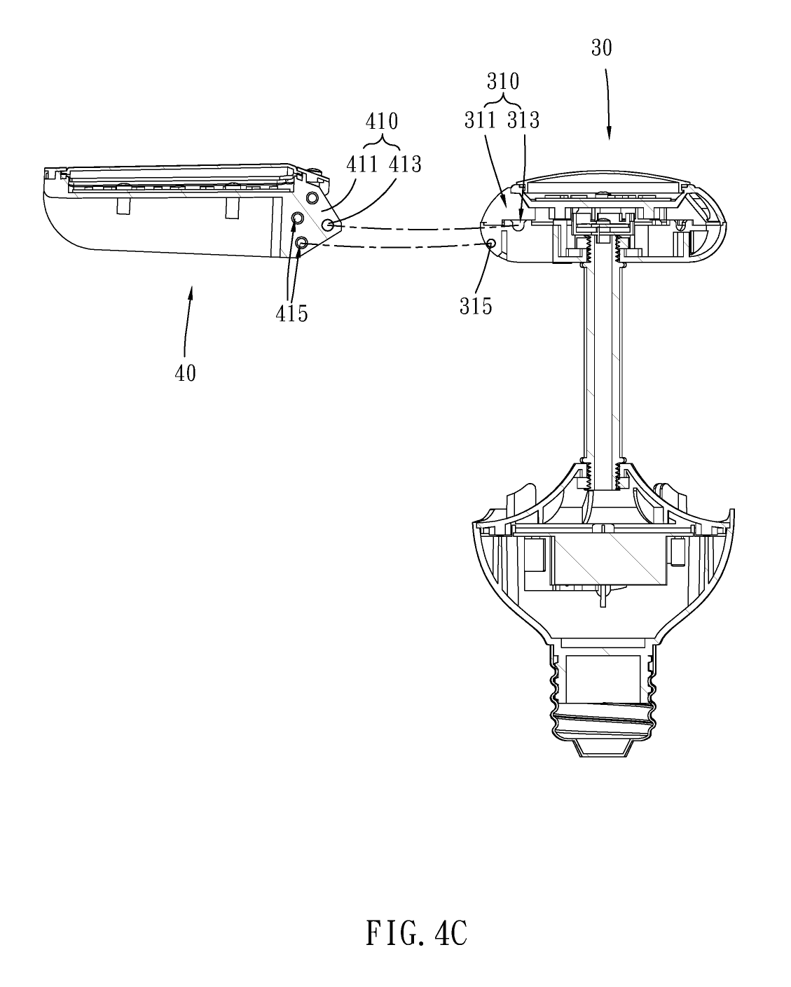

Please refer to FIGS. 4A to 4C, which show a schematic diagram, another schematic diagram, and a further schematic diagram of using the bulb structure according to an embodiment of the present invention. As shown in the figures, the present embodiment is used for illustrating the three usage states of the bulb structure 1. Each first pivot structure 310 further includes two fixing bumps 315 disposed on the two sidewalls of the pivot groove 311 and located on one side of the two pivot holes 313. Each second pivot structure 410 further includes one or more penetrating hole 415 at the pivot member 411. The two fixing bumps 315 are wedged into the two openings of the one or more penetrating hole 415, respectively.

According to the present embodiment, when the number of the one or more penetrating hole 415 is three, the three penetrating holes 415 will be located at the top, center, and bottom of the pivot member 411, respectively. As shown in FIG. 4A, the two fixing bumps 315 are wedged into the penetrating hole 415 at the top of the pivot member 411. The lamp leaves 40 of the bulb structure 1 are closed. As shown in FIG. 4B, the two fixing bumps 315 are wedged into the penetrating hole 415 at the center of the pivot member 411. The lamp leaves 40 of the bulb structure 1 are half-spread. As shown in FIG. 4C, the two fixing bumps 315 are wedged into the penetrating hole 415 at the bottom of the pivot member 411. The lamp leaves 40 of the bulb structure 1 are spread.

Besides, please refer to FIGS. 3B and 3C again. Each fixing bump 315 further includes a round head 3151 and a pillar body 3152. The round head 3151 is disposed at the pillar body 3152; the pillar body 3152 is disposed on the sidewall of the pivot groove 311. The two openings of each penetrating hole 415 include a guiding opening 4151, respectively. Thereby, as the two fixing bumps 315 are wedged into the two openings of the one or more penetrating hole 415, respectively, the round head 3151 of each fixing bump 315 may be wedged into the opening of the penetrating hole 415 having the guiding opening 4151 with ease and be fixed. In addition, by applying an external force, the two fixing bumps 315 may be removed easily from the openings of the penetrating hole 415.

Furthermore, the angle between the edges of the pivot member 411 wedged into the pivot groove 311 is 90 degrees and the two pivot bumps are disposed close to the angle. In addition, the pivot member 411 includes a plurality of penetrating holes 415. The two fixing bumps 315 are wedged into the two openings of one of the plurality of penetrating holes 415, respectively, such that the angle between each lamp leaf 40 and the base 31 is θ. Each lamp leaf 40 may pivot on the base 31 and form a plurality of angles θ with respect to the base 31. The plurality of angles θ correspond to the location of the plurality of penetrating holes 415, respectively. According to the present embodiment, the number of the one or more penetrating hole 415 is three. The three penetrating holes 415 are disposed corresponding to the twp pivot bumps 413. The distances between the pivot bump 413 to the three penetrating holes 415 are identical. Besides, the three penetrating holes 415 are located at the top, bottom, and 45-degree locations. Thereby, when each lamp leaf 40 of the bulb structure 1 pivots on the transmission base 30, it may be turned to the angles of 0 degree (as shown in FIG. 4A), 45 degrees (as shown in FIG. 4B), and 90 degrees (as shown in FIG. 4C). The lamp leaf 40 may be fixed temporarily. That is to say, the two fixing bumps 315 are wedged into the two openings of one of the three penetrating holes 415 temporarily.

If the angle between the edges of the pivot member 411 wedged into the pivot groove 311 is less than 90 degrees, the pivot member 411 will not have the corresponding area to dispose the three penetrating holes 415. If the angle between the edges of the pivot member 411 wedged into the pivot groove 311 is greater than 90 degrees, the pivot member 411 will have sufficient areas to dispose the three penetrating holes 415. Although each lamp leaf 40 may pivot over 90 degrees, the lighting range of the bulb structure 1 is limited if this happens, which is disadvantageous to the applications of the bulb structure 1. In addition, the volume of each lamp leaf 40 is increased relatively, resulting in increased overall volume, weight, and cost of the bulb structure 1. Consequently, the most appropriate design of the angle between the edges of the pivot member 411 wedged into the pivot groove 311 should be 90 degrees.

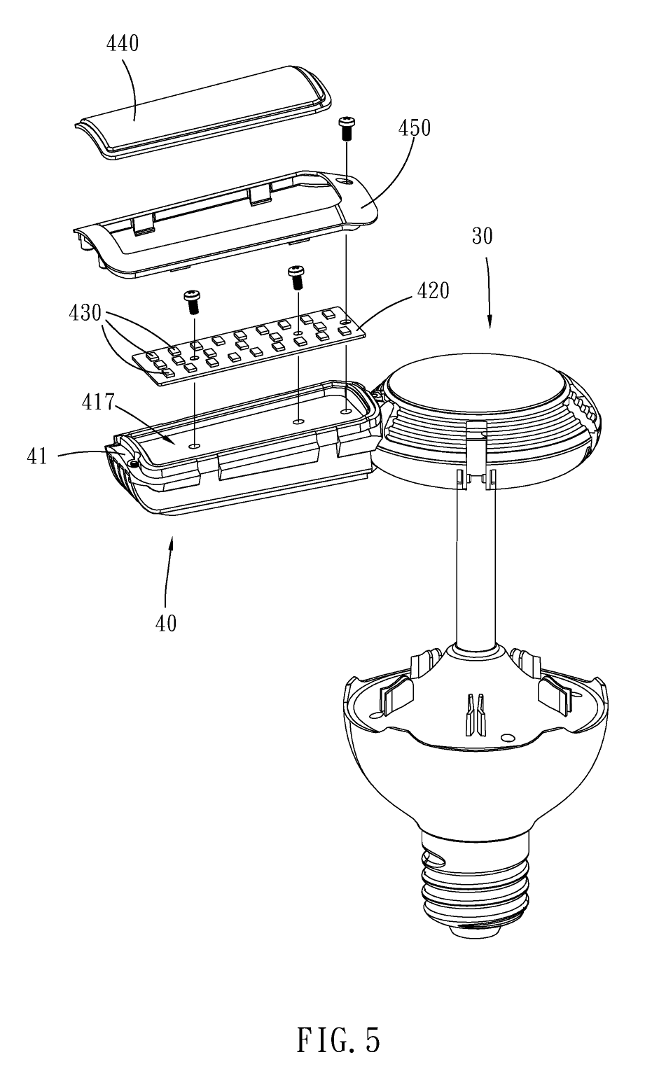

Please refer to FIG. 5, which shows a stereoscopic view of the lamp leaf of the bulb structure according to an embodiment of the present invention. As shown in the figure, according to the present embodiment, each lamp leaf 40 further includes a base board 420 and a plurality of LED chips 430. The housing 41 includes a lamp-leaf accommodating cavity 417. The base board 420 is disposed in the lamp-leaf accommodating cavity 417. The plurality of LED chips 430 are disposed on the base board 420. Besides, each lamp leaf 40 further includes a lampshade 440 and a heat sink 450. The lampshade 440 is disposed over the lamp-leaf accommodating cavity 417. The heat sink 450 surrounds the periphery of the housing 41 and located outside the lampshade 440. Thereby, the heat of the plurality of LED chips 430 is conducted to the base board 420 and the housing 41; the heat in the housing 41 is then conducted to the heat sink 450. By using the heat sink 450, the heat will be dissipated in the air, and thus reinforcing heat dissipation for the lamp leaf 40.

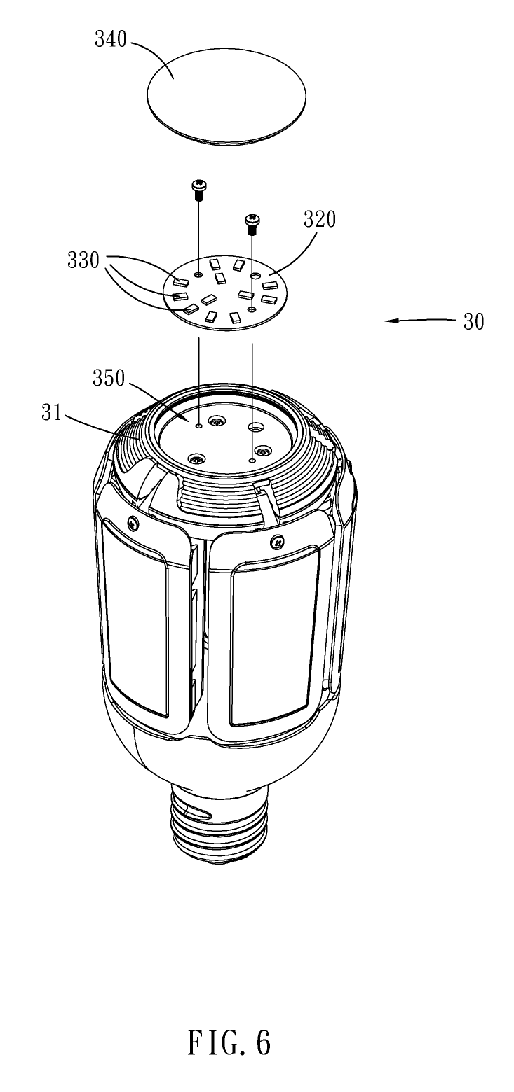

Please refer to FIG. 6, which shows a stereoscopic view of the transmission base of the bulb structure according to an embodiment of the present invention. As shown in the figure, according to the present embodiment, the transmission base 30 further includes a base board 320, a plurality of LED chips 330, and a lampshade 340. The base 31 further includes a base accommodating cavity 350. The base board 320 is disposed in the base accommodating cavity 350. The plurality of LED chips 330 are disposed on the base board 320. The lampshade 340 is disposed over the base accommodating cavity 350 and covers the plurality of LED chips 330. Thereby, the intensity of the original light may be reinforced and the lighting range may be increased in addition.

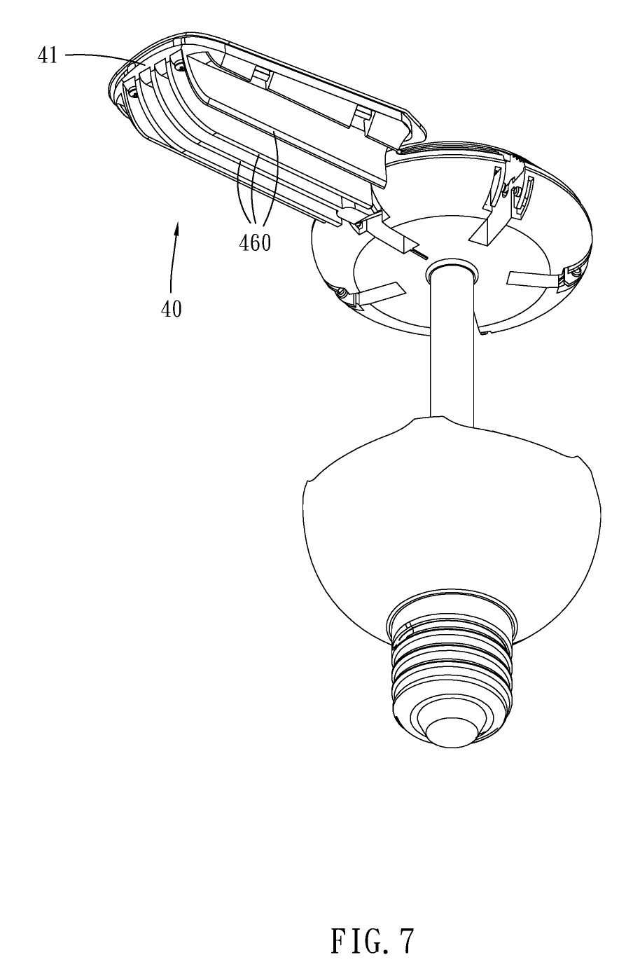

Please refer to FIG. 7, which shows a stereoscopic view of the heat dissipating fins of the bulb structure according to an embodiment of the present invention. As shown in the figure, according to the present embodiment, each lamp leaf 40 further includes a plurality of heat dissipating fins 460 disposed on one side (opposing to the side from which the lamp leaf 40 emits light) of the housing 41. The plurality of heat dissipating fins 460 are sheet-shaped and disposed in parallel on the housing 41. Thereby, the heat dissipation of the plurality of lamp leaves 40 is improved.

Please refer to FIG. 2 again. The bulb structure 1 further comprises a plurality of blocking members 110. Each blocking member 110 corresponds to one end of each lamp leaf 40 and is disposed on the bulb base 10. When the bulb structure 1 is closed, one end of each lamp leaf 40 will contact one blocking member 110. Accordingly, the pivot angles of the plurality of lamp leaves 40 of the bulb structure 1 in the closed state may be fixed. In addition, they may avoid excessive approach of the plurality of lamp leaves 40 of the bulb structure 1 to the pole member 20, which may damage the pivot axes. Moreover, according to the present embodiment, the structure design of each blocking member 110 corresponding to the plurality heat dissipating fins 460 is such that incomplete close of each lamp leaf 40 due to the blocking member 110 is avoided.

To sum up, the bulb structure according to the present invention may pivot the plurality of lamp leaves by using the transmission base. The present invention includes one or more structure states. According to requirements of users, the plurality of lamp leaves may be adjusted and changed to a spread or a closed state and thus changing the lighting range of the plurality of lamp leaves. In addition, the plurality of lamp leaves and the bulb base are disposed separately for blocking the high temperature generated by the plurality of LED chips in the plurality lamp leaves from being conducted to the driving module in the bulb base and thus maintaining normal operations of the driving module in the bulb base. Besides, the plurality of lamp leaves in the spread state may facilitate heat dissipation by improving air convection. Furthermore, the spread and close states of the plurality of lamp leaves may be used for decorating the lamp.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A bulb structure, comprising:
a bulb base;
a pole member, having one end disposed at said bulb base;
a transmission base, disposed at the other end of said pole member; and
a plurality of lamp leaves, disposed pivotally surrounding said transmission base and located surrounding said pole member, and pivoting on said transmission base and moving away from said pole member.

2. The bulb structure of claim 1, wherein:
said transmission base further includes a base, wherein said base includes a plurality of first pivot structures; each said first pivot structure includes a pivot groove and two pivot holes; and said two pivot holes are located on the two sidewalls of said pivot groove and opposing to each other; and
each said lamp leaf is disposed pivotally at said transmission base and includes a housing, wherein said housing includes a second pivot structure including a pivot member and two pivot bumps; said two pivot bumps are disposed on both sides of said pivot member and opposing to each other; said pivot member is wedged into said pivot groove; and said two pivot bumps are wedged into said two pivot holes, respectively.

3. The bulb structure of claim 2, wherein:
each said first pivot structure further includes two fixing bumps disposed on the two sidewalls of said pivot groove; and
each said second pivot structure is disposed pivotally at each said first pivot structure and includes a plurality of penetrating holes at said pivot member, wherein said two fixing bumps are wedged into the two openings of one of said plurality penetrating holes, respectively, such that each said lamp leaf forms an angle with respect to said base; and each said lamp leaf pivots on said base and includes a plurality of angles corresponding to the locations of said plurality of penetrating holes.

4. The bulb structure of claim 2, wherein:
each said first pivot structure further includes two fixing bumps disposed on the two sidewalls of said pivot groove; and
each said second pivot structure is disposed pivotally at each said first pivot structure and includes one or more penetrating hole at said pivot member, wherein said two fixing bumps are wedged into the two openings of said one or more penetrating hole, respectively.

5. The bulb structure of claim 4, wherein each said fixing bump further includes:
a pillar body, disposed on the sidewall of said pivot groove; and
a round head, disposed at said pillar body.

6. The bulb structure of claim 4, wherein the two openings of each said penetrating hole includes a guiding opening, respectively.

7. The bulb structure of claim 1, wherein each said lamp leaf includes:
a housing, having a lamp-leaf accommodating cavity;
a base board, disposed on said lamp-leaf accommodating cavity; and
a plurality of light-emitting diode chips, disposed on said base board.

8. The bulb structure of claim 7, wherein each said lamp leaf further includes:
a lampshade, disposed over said lamp-leaf accommodating cavity; and
a heat sink, surrounding said housing, and located outside said lampshade.

9. The bulb structure of claim 1, wherein each said lamp leaf further includes:
a housing; and
a plurality of heat dissipating fins, disposed on one side of said housing.

10. The bulb structure of claim 1, wherein said transmission base further includes:
a base, having a base accommodating cavity;
a base board, disposed in said base accommodating cavity;
a plurality of light-emitting diode chips, disposed on said base board; and
a lampshade, disposed over said base accommodating cavity, and covering said plurality of light-emitting diode chips.
